(19) United States
(12) Patent Application Publication
(10) Pub. No.: US 2014/0294191 A1
(43) Pub. Date: Oct. 2, 2014

(54) Hearing Protection with Sound Exposure Control and Monitoring

(71) Applicant: Red Tail Hawk Corporation, Ithaca, NY (US)

(72) Inventor: John W. Parkins, Ithaca, NY (US)

(73) Assignee: Red Tail Hawk Corporation, Ithaca, NY (US)

(21) Appl. No.: 14/226,372

(22) Filed: Mar. 26, 2014

Related U.S. Application Data
(60) Provisional application No. 61/805,671, filed on Mar. 27, 2013.

(51) Int. Cl. G10K 11/00

(52) U.S. Cl. CPC G10K 11/002
USPC 381/72

(57) ABSTRACT

A sound monitoring control for controlling the sound pressure level (SPL) delivered to the ears of a user of a hearing protection device. The control employs a measurement of the actual sound heard by the user, using a microphone to control the sound level and to help prevent noise induced hearing loss. A measurement, using a dosimeter microphone, of the actual sound pressure levels heard by the user can be used in audio processing schemes to ensure that the user is only exposed to safe levels.

### REFERENCE TO RELATED APPLICATIONS

This application claims one or more inventions which were disclosed in Provisional Application No. 61/805,671, filed Mar. 27, 2013, entitled “Talk-Through Hearing Protection with Sound Exposure Control and Monitoring”. The benefit under 35 USC §119(e) of the United States provisional application is hereby claimed, and the aforementioned application is hereby incorporated herein by reference.

### BACKGROUND OF THE INVENTION

1. Field of the Invention

This invention relates to acoustic noise monitors and dosimeters, hearing protection devices (HPDs)—for example earplugs, earbuds, headsets and helmets—hear-through systems and audio headsets and earplugs.

2. Description of Related Art

Acoustic noise dosimeters determine accumulated noise dose for a user through calculations based on the sound pressure level (SPL) measured at a given location. High noise doses can lead to noise induced hearing loss (NIHL). Acoustic noise monitors and noise dosimeters in the past were often worn on a user's body and monitored SPL at a microphone position near the head. One problem with these systems is that NIHL is typically caused by acoustic noise in the human ear canal, and this noise level may be different from the noise level measured by a noise dosimeter microphone located elsewhere.

To improve the accuracy of noise dosimetry, new devices were employed that located the noise dosimeter sensing microphone in the ear canal as seen in the prior art shown in FIG. 1a which is a side cross-sectional view. A dosimeter microphone 6 directed to the ear canal is mounted at the proximal end of an earplug 2 having a foam body 4. The proximal end is the end closest to the human eardrum when the earplug is worn in the ear, while the distal end is the end farthest from the eardrum. The dosimeter microphone 6 is electrically connected to a connector 10 using conductor bundle 8. (Note that electrical inputs and outputs from transducers and processing blocks in figures herein are indicated with a single line, drawn with an arrow indicating an output when facing a direction away from the transducer and an input when drawn with an arrow facing the transducer, even though the actual electrical connection may require multiple wires in practice.) A frontal view of the earplug 2, looking into the proximal end, is shown in FIG. 1b.

FIG. 2 shows the prior art as it can be worn in a human ear canal. In FIG. 2, the dosimeter microphone 6 directed to the ear canal is used to sense ear canal sound pressure P2 in the ear canal 18 that is caused by ambient sound P1 due to, for example, mechanical machinery. The ambient sound P1 reaches the ear canal 18 by way of earplug 2, vibration due to sound P1 forces on the distal end of the earplug 2, transmission through the earplug 2 and bone and skin flanking paths.

The proximal location of the dosimeter microphone 6 to a human eardrum 20 ensures that the microphone is sensing pressure very similar to what the eardrum 20 experiences, which is different from the ambient environment sound due to the attenuation of the earplug. A cable 12 from the connector 10 communicates with electronics 24 for processing the dosimeter microphone 6 output, as shown in FIG. 2.

FIG. 3 shows a schematic of the prior art electronics circuit 24, dosimeter microphone 6 and canal sound pressure P2. The pressure P2 sensed by dosimeter microphone 6 is converted to an electrical signal through transduction means and input to a filter 45. Typically, this is an American National Standards Institute (ANSI) A-weighted filter. Filter 45 attenuates high and low frequencies and is defined by a specific electronic transfer function. The filter 45 output is connected to a level detector 43, such as a root mean square (RMS) level detector with specified time constant. The level detector 43 output is input to a noise dosimeter 47 that keeps a calculated accumulation of the exposure to acoustic noise. Such algorithms can be found in ANSI specifications and other specifications.

Using a dosimeter microphone at the proximal end of an earplug inserted in an ear canal provides a more accurate dose measurement compared to locating the microphone elsewhere, such as worn on the user's shoulder. The earplug 2 provides a means to mechanically fix the dosimeter microphone 6 in position and provides a barrier to acoustic noise. In this way, the user is protected from ambient acoustic noise in his/her environment, and the noise level and dose can be monitored using a noise dosimeter circuit. A worker may wear this prior art invention during a shift and the total noise dose received by the worker can be recorded at the end of the day, if desired, by downloading the noise dose data from the electronics circuit 47. Moreover, the worker may be alerted when his/her maximum noise dose has been received by use of a warning light indicator connected to the electronics circuit 24.

A significant problem with earplug and other hearing protection noise dosimetry devices is that the HPD often provides noise attenuation at times when it is not desired. The user may need noise attenuation sporadically during a work day, for example when operating loud machinery, but may want to hear at normal levels, for example when the machinery is turned off, to have a face-to-face conversation or to regain situational awareness. Typically, the user must remove the earplug (or other HPD) if he/she wants to hear ambient sounds at normal levels.

Hear-through HPDs (also called “talk-through HPDs”) allow ambient sounds to bypass or be “fed through” the hearing protection electro-acoustically. Typically, a microphone directed to the outside of the HPD converts the ambient sound to an electrical signal which passes through electronics and amplifiers to a speaker that recreates the ambient sound for the user to hear. Often, the hear-through HPD provides a manual volume control to control the level of the ambient sound heard by the user. However, these systems currently do not automatically control the sound volume they produce as a function of a measurement that reflects the user's noise exposure as described herein, and the user may inadvertently subject himself/herself to damaging noises and noise doses due to the manual volume control being set too high.

For the purposes of the invention described herein, a “microphone directed to the ambient environment” senses sound of the ambient environment while a “microphone directed to the ear canal” substantially senses sound in the volume defined by the ear canal, eardrum, human skin and inner HPD barrier. For a circumaural earcup, a microphone installed on the outside of the earcup surface with the microphone diaphragm acoustically coupled to the ambient environment would be considered a microphone directed to the ambient environment, while a microphone installed within the earcup with the microphone diaphragm acoustically coupled to the interior of the earcup and ear canal would be considered a microphone directed to the ear canal.

A microphone directed to the ear canal senses the sound substantially heard by the user. The sound substantially heard by the user includes any sound that penetrates the HPD and any sound generated within the HPD by a sound-producing transducer, such as a moving coil, balanced armature, piezoelectric, MEMS or other speaker types. A microphone directed to the ear canal may be frequency compensated to more accurately measure the sound heard at a user's eardrum.

### SUMMARY OF THE INVENTION

The disclosure presents a sound exposure control for controlling the sound pressure level (SPL) delivered to the ears of a user of a hearing protection device. The control employs a measurement of the actual sound heard by the user, using a microphone directed to the ear canal to control the sound level and to help prevent noise induced hearing loss. A measurement, using a dosimeter microphone, of the actual sound pressure levels heard by the user can be used in audio processing schemes to ensure that the user is only exposed to safe levels.

### BRIEF DESCRIPTION OF THE DRAWING

FIG. 1a is a cross-sectional view of prior art.

FIG. 1b is a frontal view of prior art from FIG. 1a.

FIG. 2 is a cross-sectional view of prior art of FIG. 1a as it is worn in an ear canal.

FIG. 3 is a schematic of prior art from FIG. 1a.

FIG. 4 is a cross-sectional view of an embodiment of the invention as worn in an ear canal.

FIG. 5 is a frontal view of the embodiment of the invention shown in FIG. 4.

FIG. 6 is a block diagram of an embodiment of the invention.

FIG. 7 is a block diagram of another embodiment of the invention.

FIG. 8 is a cross-sectional view of an embodiment of the invention when incorporating a custom-molded earplug.

FIG. 9 is a cross-sectional view of an embodiment of the invention when incorporating a custom-molded earplug and a dosimeter microphone positioned at the proximal end of the earplug.

FIG. 10 is a cross-sectional view of an embodiment of the invention incorporation a headset earcup and an additional audio source.

FIG. 11 is a block diagram of an embodiment of the invention incorporating an additional audio signal.

FIG. 12 is a block diagram of an embodiment of the invention incorporating feed-forward active noise control.

FIG. 13 is a block diagram of an embodiment of the invention incorporating feedback active noise control.

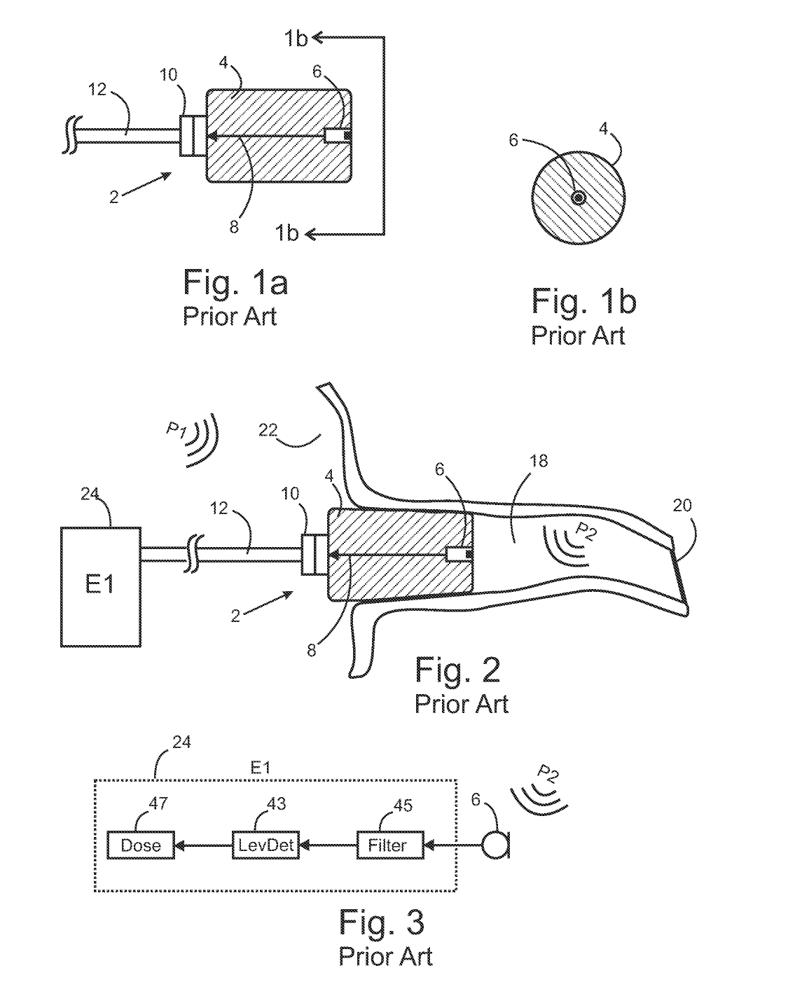

### DETAILED DESCRIPTION OF THE INVENTION

A preferred embodiment of the invention employs a dosimeter microphone to monitor noise exposure of the user between the HPD and the user's ear and an ambient microphone to sense ambient sounds of the user's environment. Electronics coupled to the electrical output of the ambient microphone can amplify or attenuate the microphone output signal and drive a speaker to bypass the hearing protection of an HPD and provide what is called “hear-through” function. Electronic circuitry monitors the electrical output of the dosimeter microphone and reduces the gain of the hear-through signal automatically, if needed, to ensure that no damaging sounds reach the user's ear.

If the circuitry has completely attenuated the hear-through signal and the sound level measured by the dosimeter microphone is above a threshold, an embodiment of the invention engages active noise control (ANC) to protect the ears of the user.

In one embodiment of the invention, a user controlled manual volume control is provided to allow the user to amplify or attenuate ambient sounds as heard in the ear canal. Typically, the invention is used with both ears. However, for simplicity, only one channel for one ear of the invention is shown in the following figures.

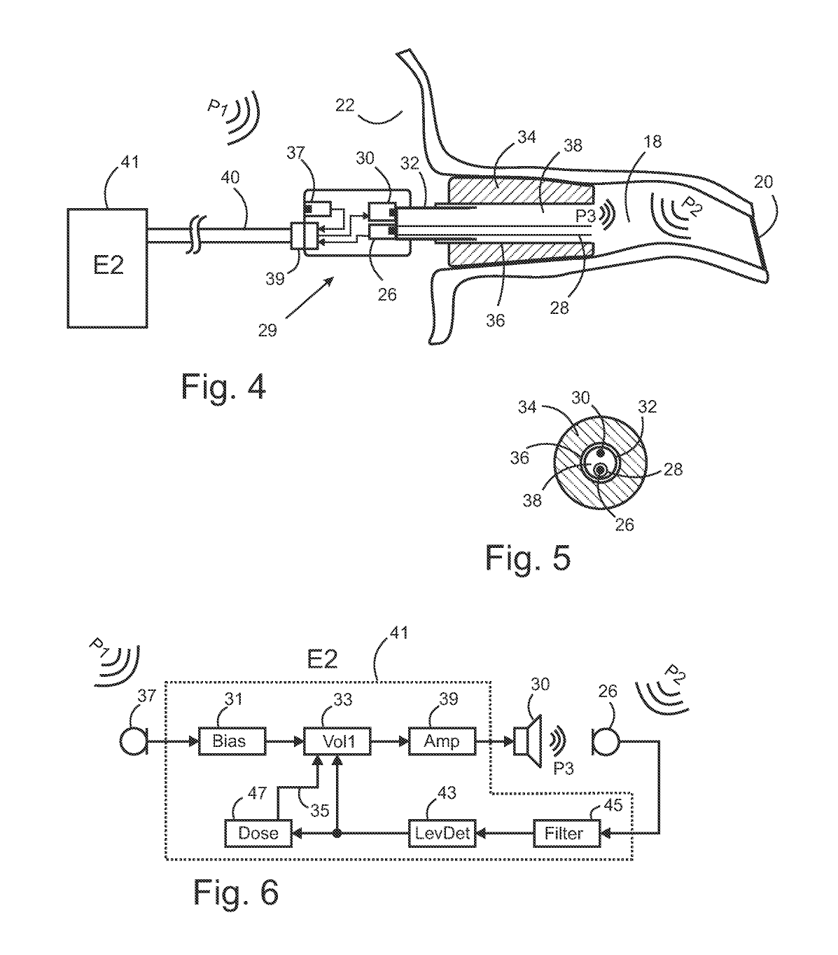

FIG. 4 is an embodiment of the invention shown in an ear canal 18 that is an improvement over the prior art shown in FIG. 2. This embodiment is a generic-fit device that can be worn by users of differing ear canal and concha geometries. As opposed to the prior art shown in FIG. 2, the embodiment of the invention shown in FIG. 4 incorporates an earplug 29 with an ambient microphone 37 having an input that senses sound P1 outside the HPD. The earplug 29 is inserted into the ear canal 18; however, portions of the earplug 29 may extend outside the ear canal into the concha region 22.

This embodiment incorporates a canal sensing dosimeter microphone 26 whose input is acoustically coupled to a probe tube 28 for sensing canal sound pressure P2. The probe tube 28 may be user replaceable if it becomes clogged or damaged.

A sound generating transducer or speaker 30 is incorporated in this embodiment, having an output that generates speaker sound pressure P3 in response to electrical signals at an electrical input. The speaker 30 is acoustically coupled to an adapter 32 that is mechanically and acoustically coupled to a foam eartip 34 with eartip core 36. The core 36 provides a means of mechanically attaching the eartip 34 to the adapter 32. The eartip 34 with core 36 is user replaceable in this embodiment. The foam eartip 34 compresses within the ear canal 18 to conform to the canal 18 and provide a generally reasonable acoustical seal. Within the core 36 of the eartip 34 is a sound channel 38 that provides a means for the sound generated by the speaker 30 to reach the canal 18.

The ambient microphone 37, canal sensing dosimeter microphone 26 and speaker 30 are all electronically coupled to connector 39. The input and output signals of these transducers are electronically coupled to electronics 41 via a multi-conductor cable 40. Note that a bias circuit is not shown for dosimeter microphone 26. Also note that an equalization circuit, not shown, may be needed for dosimeter microphone 26 to compensate for the probe tube response and any other compensation.

The purpose of the probe tube 28 in this embodiment is to sense the sound pressure within the ear canal 18 rather than the sound pressure within the core 38, which may be different. Due to the acoustic impedance of the core 38, sound pressure generated by the speaker 30 within the core 38 is generally higher than the sound pressure P3 from the speaker 30 that reaches the ear canal 18. The pressure sensed by the eardrum is the sum of the speaker sound pressure P3 and flanking sound pressure P2, and this sum is sensed by the dosimeter microphone 26 using the probe tube 28

FIG. 5 shows a frontal view of the embodiment of the invention depicted in FIG. 4 looking into the proximal end. The foam eartip 34 has a generally cylindrical shape when not compressed as shown in this figure. The probe tube 28 is generally cylindrical in this embodiment and the canal sensing dosimeter microphone 26 can be seen at the back end of the tubing 28. The speaker 30 generates sound that travels within the region of the core 36 and adapter 32 not occupied by the probe tube 28. The probe tube 28 is made of a material stiff enough that sound generated by the speaker 30 does not penetrate its walls to a significant degree.

FIG. 6 shows a schematic block diagram of the electronics within electronics system 41, shown as box E2 in FIG. 4. The ambient microphone 37 senses ambient sound P1. Bias circuitry 31 provides voltage and any filtering for microphone 37. The output of the bias circuitry 31 is coupled to an automatic volume control 33 that is automatically controlled by a level detector 43. The output of the volume control 33 is input to an amplifier 39 that provides amplification of the signal for speaker 30 creating speaker-generated sound P3 providing an electro-acoustic bypass path for the hear-though signal.

The ambient sound P1 travels via flanking paths (through the earplug, causing the earplug to vibrate and around the earplug through skin and bone) into the canal and generates flanking pressure P2. The dosimeter microphone 26 senses pressure in the canal that includes the sum of pressures P2 and P3. The dosimeter microphone 26 output is connected to a filter 45, such as an ANSI-defined A-weighted filter. The filter 45 output is input to a level detector 43 such as an RMS detector with specified time constant. The output of the level detector 43 is input to a noise dosimeter 47. However, in this embodiment of the invention the output of the level detector is also used to automatically control volume control 33.

In this way, the ambient pressure P1 can be fed into the canal via electro-acoustic means and monitored by dosimeter microphone 26. The level of the sound pressure in the canal measured by dosimeter microphone 26, which is at least the sum of P2 and P3, can be used to automatically adjust the volume control which will modify how much of the ambient sound P1 is fed into the user's ear canal. At the same time, the level detector 43 output is input to a noise dosimeter 47.

The total noise dose accumulates over a period of time. This noise dose can be stored in the circuit for later retrieval to keep track of a factory worker's total noise dose during a shift, for example. If a maximum noise dose of a user has been exceeded, the noise dosimeter can communicate with the volume control 33 via signal path 35 to turn the volume off and shut down the hear-through function.

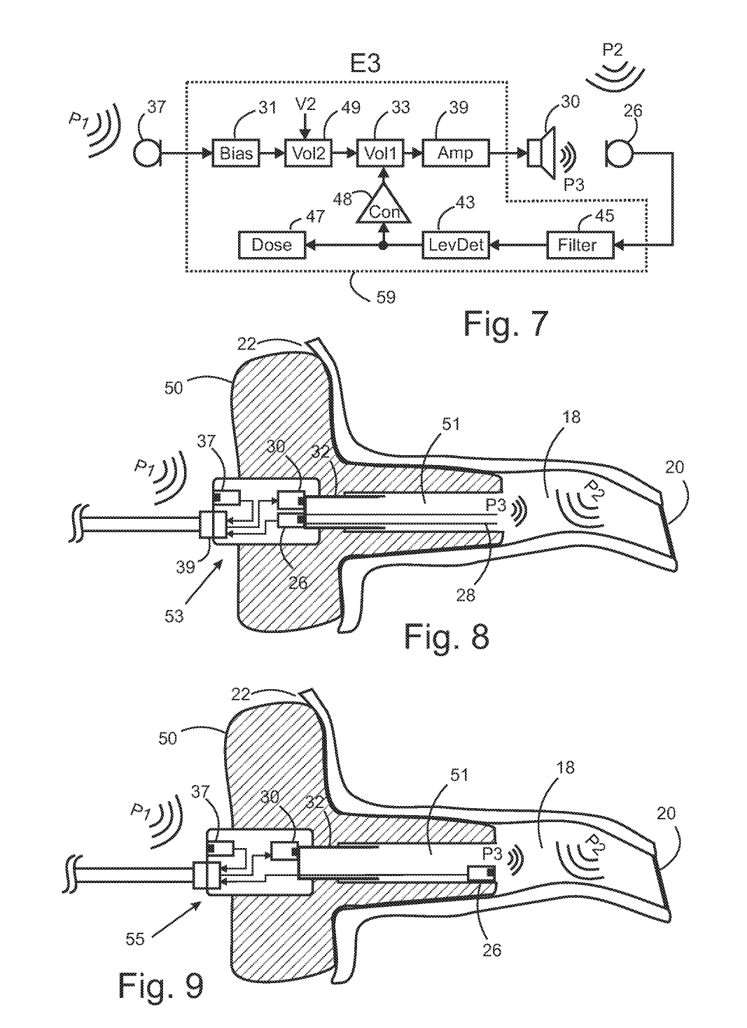

FIG. 7 shows a block diagram of an embodiment similar to the embodiment shown in FIG. 6; however, a user-controlled volume control 49 has been added. The user volume control 49 is controlled by voltage V2 that may be generated by a manually-adjusted potentiometer (not shown) connected to a voltage source (not shown). By turning the potentiometer, the voltage V2 is changed and used to amplify or attenuate the audio signal output of the bias circuitry 31.

In this way, the user turns up or down the sound level P3 of the ambient sound P1 delivered by the speaker 30. However, if the SPL in the canal is high enough, controller 48 will automatically send a voltage to volume control 33 and override volume control 49 by reducing the overall volume level. If the user attempts to increase the SPL in the ear canal above safe levels by increasing volume control 49 too high, the dosimeter microphone 26, filter 45, and level detector 43 will sense this, and the system will automatically reduce the SPL by lowering volume control 33 using controller 48.

FIG. 8 shows an embodiment of an earplug 53 where the earplug 29 components shown in FIG. 4, without eartip 34 and core 36, are partially embedded in a custom-molded body 50 shaped to fit a user's ear canal 18 and concha 22. This custom-fit embodiment can produce a more comfortable fit compared to the generic-fit embodiment shown in FIG. 4. The probe tube 28 extends in the sound channel 51 to the proximal end of the earplug 53 to sense sound in the ear canal 18. The custom-molded body 50 can be made of rigid material, such as plastic, or resilient material, such as silicone or other materials.

FIG. 9 shows an embodiment of an earplug 55 similar to the embodiment shown in FIG. 8 except that the dosimeter microphone 26 no longer employs the probe tube 28 of FIG. 8 because in this embodiment, the dosimeter microphone 26 is in sound channel 51, attached to a region at the proximal end of the earplug 55 and close to the occluded ear canal 18 and near the eardrum 20.

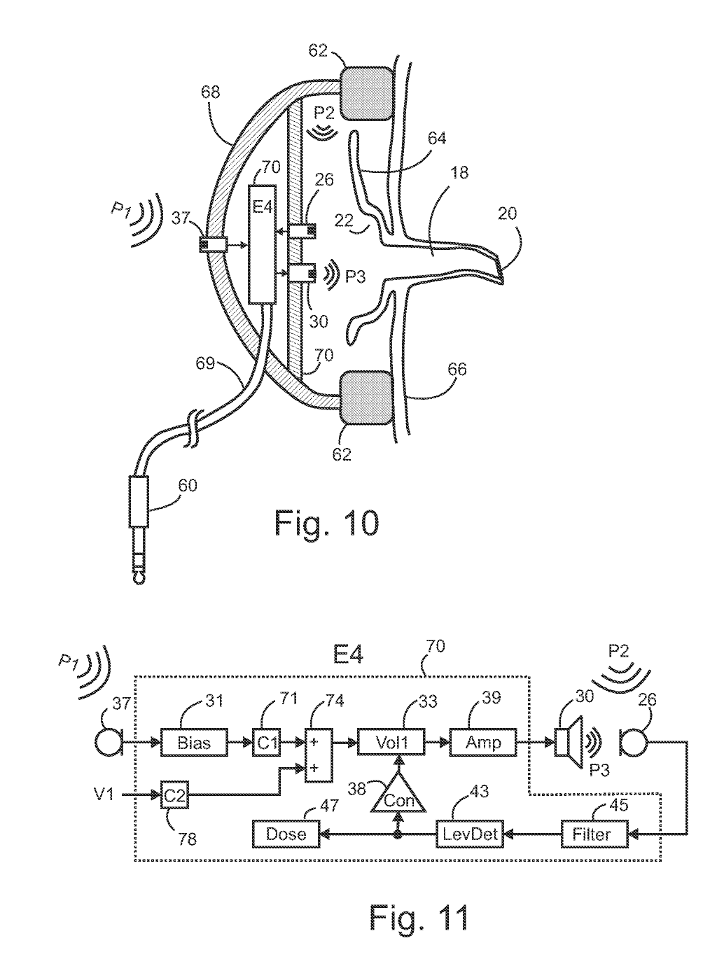

FIG. 10 is a cross-sectional view that shows an embodiment of the invention employing an earcup 68 of a headset (not shown). Typically, two earcups would be employed in the headset (not shown) to protect the user's ears from detrimentally high ambient acoustic noise.

Earcups typically employ a resilient ear cushion 62 to seal the earcup 68 to the user's head 66 and prevent ambient sounds P1 from reaching the eardrum 20. The ambient sound P1 that penetrates the earcup 68 or leaks into the earcup 68 is indicated as P2 and is sensed by both dosimeter microphone 26 and the eardrum 20. The dosimeter microphone 26 and eardrum 20 also sense the pressure P3 generated by speaker 30.

In FIG. 10, a cross section of the ear pinna 64, ear concha region 22 and ear canal 18 can be seen. Ambient microphone 37 is mounted to the earcup 68 to sense ambient sounds in this embodiment. The output of the microphone 37 is input to an electronics system 70. Dosimeter microphone 26 senses sound within the earcup that is also sensed by the eardrum 20. The ambient microphone 37 and dosimeter microphone 26 outputs are input to electronics system 70.

The electronics system 70 processes these outputs and produces a speaker 30 signal input. A communications cable 69 is attached to a communications connector 60 that can be plugged into an audio source such as a radio, phone, MP3 player or other audio source. Boom microphones (not shown) may also be employed in the system for sensing the user's speech for communications purposes.

FIG. 11 shows a block diagram of an embodiment of the electronics system 70 from FIG. 10. An audio signal V1 from connector 60 of FIG. 10 is input to electronics system 70. This signal V1 may be processed by an audio processor 78 that may provide processing such as equalization, limiting, automatic gain control, user volume control and compression among other processing functions. Ambient microphone 37 bias circuit 31 output may also be processed by a similar audio processor 71 providing similar functions as processor 78. The processors 71 and 78 outputs are summed in summer 74 and the summer 74 output is input to an automatic volume control 33 that is controlled by a voltage generated by controller 38. The volume control 33 output is input to an amplifier 39 for driving a speaker 30.

The speaker 30 sound pressure P3 and the flanking sound pressure P2 are sensed by dosimeter microphone 26, and microphone 26 output is input to a filter 45 that in a preferred embodiment has the characteristics of an ANSI A-weighted filter, commonly used in noise dosimetry. The filter 45 output is processed by a level detector 43 that in the preferred embodiment outputs the RMS level of the filter 45 output. Level detector 43 output is input to noise dosimeter 47 where the accumulating noise dose is calculated.

In this embodiment, the level detector 43 is input to controller 38 that automatically controls the volume of the summed audio processor 71 output and audio processor 78 output. If damaging SPLs are detected at dosimeter microphone 26, the volume of the pressure generated by speaker 30 can be attenuated automatically to protect the users hearing.

In another embodiment of the invention, audio signal V1 may bypass the volume control 33 and be summed into amplifier 39. This may be useful if the audio signal V1 is a critical communications signal that should never be attenuated. However, in this embodiment, the ambient bypass signal would be controlled by controller 38.

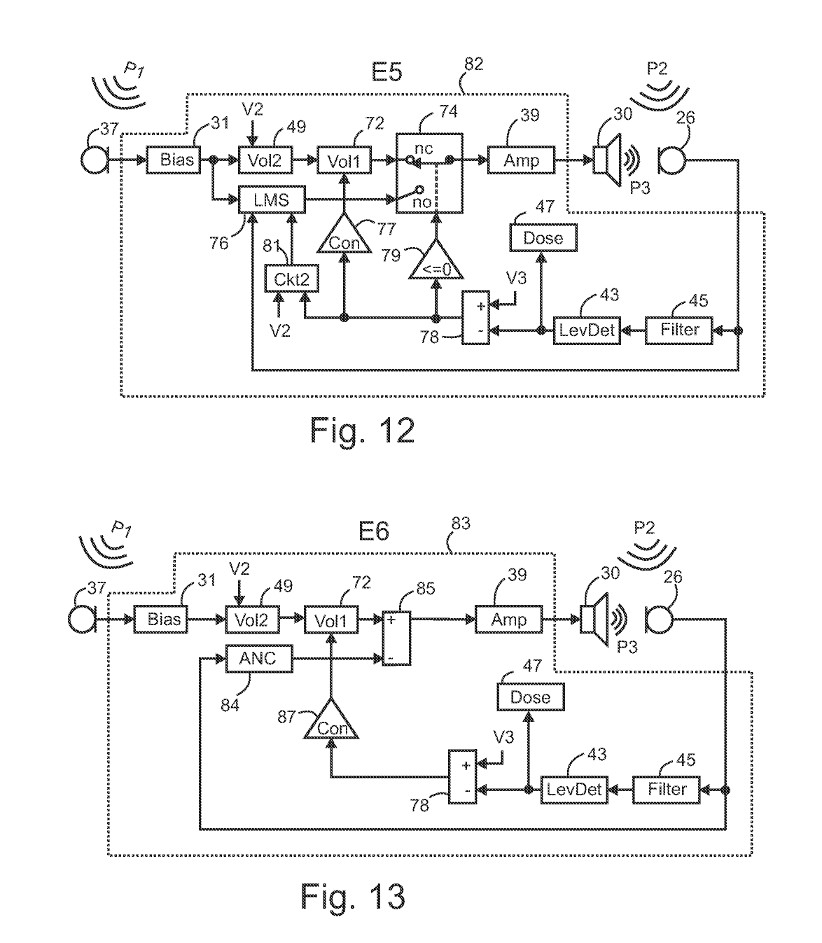

FIG. 12 shows a block diagram of a preferred embodiment of the invention that could be employed with an earplug, headset, helmet or other HPD. Elements with the same labels as previous figures perform the same functions.

This embodiment of the invention employs feed-forward active noise control (ANC). When dosimeter microphone 26 is sensing safe SPLs near the user's ear, the system will remain in hear-through mode and provide the hear-through function, and the user is able to increase or decrease the volume of the ambient sound P1 fed through electronics system 82 by increasing or decreasing voltage V2 by using a potentiometer or other electronic means not shown. If the dosimeter microphone 26 is sensing unsafe SPLs, the system will attenuate the hear-through function using controller 77 and automatic volume control 72. If, when the hear-through function is fully attenuated, dosimeter microphone 26 is still sensing unsafe SPLs the system will activate the ANC function using switch 74.

In the preferred embodiment, positive voltage V2 indicates the user would like to amplify the ambient feed-through sound (such as when a hunter needs to amplify quiet sounds). Negative voltage V2 would indicate the user would like to attenuate the ambient feedthrough sound (such as when a traveler is flying in a commercial aircraft). A V2 voltage of zero volts would indicate the user would like to hear ambient feed-through sound at normal levels. That is, when V2 equals zero volts, the user should not notice a significant difference in volume of ambient sound with or without wearing the invention.

The level detector 43 output is compared with a reference voltage V3 that corresponds to a level predefined by the user for safe listening, for example 80 dBA.

If the level sensed by the dosimeter microphone 26 is higher than 80 dBA, a summer 78 will output a negative voltage, and controller 77 will cause volume control 72 to attenuate the ambient signal level. If after completely attenuating the ambient fed through signal, the detector 43 is still above the reference voltage V3, detector 79 will send a control signal to switch 74 to switch to the normally open “no” contact. This will disable the hear-through function and enable the ANC function.

If the level sensed is equal to 80 dBA, in this example, the summer 78 will output 0 volts, and the normally open contact “no” will be engaged. This will also disable the hear-through function and enable the ANC function.

If the level sensed is less than 80 dBA, the summer 78 will output a positive voltage and the detector 79 will activate the normally closed “nc” contact, and the hear-through function will be enabled. The time constant for enabling and disabling switch 74 should be relatively long to prevent the system from cycling between states too rapidly, which would be an annoyance to the user and is slow compared to the time constant of controller 77.

When the normally open contact “no” is activated, the ambient microphone 37 biased circuit 31 output is processed by a feed-forward ANC processor 76, such as least mean square or other feed-forward techniques commonly known in the art, and routed through switch 74 to amplifier 39. Typical feed-forward ANC processors employ a reference signal, here provided by ambient microphone 37 and bias circuit 31 output, and an error signal, here provided by dosimeter microphone 26.

The amplifier 39 output is input to the speaker 30 which creates a pressure P3 that is generally an inverted image of pressure P2. The two pressures, P3 and P2, sum acoustically in a destructive way so that the resulting pressure is less than P2 alone. In this way, the sound heard by the user is attenuated not only by the HPD, but by the use of an ANC signal.

In a preferred embodiment of the invention, the summer 78 output is input to circuit 81 for processing. The user controlled volume signal V2 is also input to circuit 81. Circuit 81 can provide controlling signals to the ANC processor 76 to deliberately limit the performance of the ANC circuitry typically by reducing the gain of the feedforward filter within ANC processor 76.

In this way, the system can provide ANC to attenuate the signal heard by the user to safe levels, but not attenuate the signal completely. The amount of residual signal not attenuated is determined by the user with V2. The more negative V2 is, the greater the effect of ANC will be and a lower SPL will be heard by the user. However, in all situations, the system overrides the user to ensure that only safe SPLs are heard.

During use, the noise dose is also being monitored and measured by dosimeter 47 to ensure that the user has not received his/her maximum daily dosage. As the maximum dose is approached, the system can generate a beeping sound (not shown) or warn the user in some other fashion, such as a light indicator. Moreover, if the maximum dose is achieved, the system can automatically turn off the hear-through function and activate the ANC system at full performance, all in an effort to protect the user's ears to the greatest extent. This can be achieved by sending a signal from the dosimeter 47 to detector 79 and circuit 81 and providing simple logic control (not shown).

FIG. 13 shows a block diagram of an embodiment of the invention with electronic circuit 83 incorporating a feedback ANC filter 84. In this embodiment, the output of dosimeter microphone 26 is input to the feedback ANC filter 84. The output of the ANC filter 84 is input to the negative terminal of summer 85 which is then amplified by amplifier 39 to drive speaker 30. In this way, a negative feedback loop is created.

The ANC system will tend to try to faithfully produce the signal at the positive terminal of the summer 85 while minimizing disturbances caused by noise P2, as is known in the art. In this way, the passive attenuation and active cancellation of the system tends to create a quiet environment for the user except to the extent that the ambient environment acoustic information is fed through the system using ambient microphone 37. The user can control how much ambient sound is heard by the user by adjusting a potentiometer or other means to control a voltage V2 that controls a volume control 49.

In FIG. 13, the dosimeter microphone 26 is also used to measure the noise exposure of the user by means of an a filter 45, A-weighted in this embodiment, an RMS level detector 43 and a noise dosimeter 47 that keeps track of the noise dose. If the total noise exposure determined by noise dosimeter 47 has reached a threshold value, the user may be alerted using a warning light or warning sounds. In addition, the total noise dose may be saved the memory of the noise dosimeter to be retrieved at a later time.

If the level detected by level detector 43 in FIG. 13 is higher than a predetermined voltage V3 that corresponds to a sound pressure level, summer 78 will output a negative voltage. If the summer 78 output voltage is less than zero, the threshold level has been exceeded, and a controller 87 automatically generates a signal to lower the volume setting of volume control 72. In this way, the system monitors the SPL that the user is exposed to and will turn down the ambient bypass signal to prevent hearing damage.

The volume of the ambient sound fed through the system is set by the user using control voltage V2; however, if the user is being exposed to damaging SPLs, the system overrides the user and turns down the volume by adjusting volume control 72.

In another embodiment similar to that shown in FIG. 13, ambient microphone 37 is replaced with a different audio source, such as a music player or radio, or multiple audio sources. Controller 87 or additional controllers could be used to automatically control the volume levels of these audio sources based on the dosimeter microphone 26 output and override the volume level set by the user to protect against hearing damage.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hearing protection device to be worn by a user, comprising:
a) a dosimeter microphone having an input acoustically coupled to the user's ear canal for sensing ear canal sound pressure, and an electrical output representative of the ear canal sound pressure;
b) a sound generating transducer having an electrical input and an output acoustically coupled to the user's ear canal for generating a speaker sound pressure in response to a signal on the electrical input;
c) a level detector having an input coupled to the electrical output of the dosimeter microphone and an output related to the ear canal sound pressure sensed by the dosimeter microphone; and
d) an automatic volume control having an input coupled to the output of the level detector, an audio source input, and an output coupled to the electrical input of the sound transducer, such that signals at the audio source input cause a speaker sound pressure generated by the sound generating transducer, the speaker sound pressure being controlled by the automatic volume control based on the ear canal sound pressure level sensed by the dosimeter microphone.

2. The hearing protection device of claim 1, further comprising an acoustic noise dosimeter having an input coupled to the output of the level detector, an accumulator for storing an accumulated noise dose over time

3. The hearing protection device of claim 2, in which the dosimeter further comprises an output coupled to the accumulator, the output being activated when the accumulated noise dose over time exceeds a predetermined maximum noise dose.

4. The hearing protection device of claim 3, in which the output of the acoustic noise dosimeter is coupled to the automatic volume control such that when the accumulated noise dose reaches the predetermined maximum noise dose, the speaker sound pressure level generated by the sound generating transducer is attenuated.

5. The hearing protection device of claim 1, wherein the acoustic input of the dosimeter microphone is coupled to the ear canal through a probe tube.

6. The hearing protection device of claim 1, further comprising an active noise control system having an input coupled to the output of the dosimeter microphone and an output coupled to the ear canal.

7. The hearing protection device of claim 1, in which the electrical output of the dosimeter microphone is coupled to the input of the level detector through an A-weighted filter.

8. The hearing protection device of claim 1, in which the level detector is a root mean square level detector.

9. The hearing protection device of claim 1, in which the automatic volume control further comprises a user volume control for controlling the speaker sound pressure, the user volume control being overridden by the automatic volume control when sound levels measured by the dosimeter microphone are above a predetermined level.

10. The hearing protection device of claim 1, further comprising an earplug for fitting at least partially within a user's ear canal, having a body with a proximal end closest to the user's eardrum when the earplug is in the user's ear canal, a distal end nearest an ambient environment and furthest from the eardrum, and a sound channel passing through the earplug body to the proximal end.

11. The hearing protection device of claim 10, in which the earplug is a custom-molded earplug shaped to fit the user's ear canal and concha.

12. The hearing protection device of claim 10, in which the dosimeter microphone and the sound generating transducer are at least partially embedded in the earplug.

13. The hearing protection device of claim 1, further comprising an external electrical input for coupling to an audio source, coupled to the audio source input of the automatic volume control.

14. The hearing protection device of claim 1, further comprising an ambient microphone having an input acoustically coupled to the ambient environment and an electrical output representative of ambient sound pressure coupled to the audio source input of the automatic volume control.
